(19) United States
(12) Patent Application Publication
(10) Pub. No.: US 2009/0021105 A1
(43) Pub. Date: Jan. 22, 2009

(54) ROTOR FOR AN ELECTRIC MACHINE AND PRODUCTION METHOD THEREOF

(76) Inventor: Steven Andrew Evans, Buehl (DE)

Correspondence Address: MICHAEL J. STRIKER, 103 EAST NECK ROAD, HUNTINGTON, NY, 11743, US

(21) Appl. No.: 12/278,520

(22) PCT Filed: Jun. 29, 2007
(86) PCT No.: PCT/EP07/56574

§ 371 Date: Aug. 6, 2008

(30) Foreign Application Priority Data
Jul. 12, 2006 (DE) 102006032215.0

(51) Int. Cl. H02K 1/27; H02K 15/03

(52) U.S. Cl. 310/261; 29/598

(57) ABSTRACT

The present invention relates to a rotor for an electric machine, comprising a core made of metal lamellar sheets (1), which are disposed on a motor shaft (2), wherein the metal lamellar sheets (1) of the core are made of a two-state steel and have a low relative permeability in an inner region (3), in which the motor shaft (2) is attached to the metal lamellar sheets (1). Furthermore the invention relates to a production method of such a rotor.

### RELATED ART

The present invention relates to a rotor for an electrical machine, in particular a brushless, permanent-magnet, consequent-pole machine that includes a core composed of metal lamellar sheets located on a motor shaft.

Brushless, permanent-magnet, consequent-pole machines are used largely in applications in which costs are to be minimized, e.g., in the automotive industry. With consequent-pole machines, the number of permanent magnets in the electric motor is reduced, in order to lower the production and manufacturing costs without reducing the number of poles or the output-to-weight ratio. This is attained, e.g., by using soft-magnetic pole shoes instead of south pole permanent magnets, and by designing the north pole permanent magnets with twice the thickness, in order to hold the electromotive force in the rotor of the machine constant, to reduce the d-axis flux, and to prevent a reduction in the torque produced by the machine. The flux that exits the soft-magnetic south poles is generated due to the repulsion of the pole-like flux of the north pole permanent magnets.

The manufacturing costs of the permanent magnets per kg material are lower for a consequent-pole machine due to the reduced number of permanent magnet surfaces that must be machined (e.g., wire-cut EDM), since there are only half as many permanent magnets in the electric motor. In addition, the rotor is easier to assemble and the manufacturing costs are lower, since only half as many permanent magnets need be installed in the rotor lamellar stack.

Consequent-pole machines have the disadvantage, however, that a loss of flux occurs along the motor shaft of the machine when a magnetic steel shaft is used, which is typically the case. Not all of the south pole flux, which is generated by the north pole permanent magnets, leaves the soft-magnetic, south-pole pole shoes—where the air gap is bridged and the windings are connected—in order to produce a torque. A certain amount of this flux flows into the shaft and therefore does not contribute to the production of torque, thereby resulting in a reduction in the output-to-weight ratio of the machine.

The problem of stray flux in the shaft is more pronounced in machines with larger gap widths, e.g., in machines used in integrated water pumps in motor vehicles. With these electric motors, the magnetic gap width may typically be 2.3 mm, compared with approximately 0.5 mm in normal electric motors. The magnetic gap width is so great because
(a) the rotor, which runs as a wet rotor in the water to be pumped, must be encapsulated, e.g., in a housing made of stainless steel that is typically 0.2 mm thick, in order to protect the rotor lamellar stack and the permanent magnets from corrosion; this is particularly important when the permanent magnets are made of neodymium iron boron (NdFeB);
(b) the rotor is separated from the dry stator by a plastic cover that encloses the rotor; this cover must be thick enough that it is not bent by the pressure that exists in the pump, and it is typically 1.2 mm thick; and
(c) a mechanical gap between the rotor housing, which is made of stainless steel, and the inner wall of the plastic cover, in which the water flows, must be at least 0.8 mm thick, since the water may contain particles that are up to 0.6 mm in size and must flow through the pump without blocking the rotor and therefore stopping the pump.

This large magnetic gap generates a magnetic reluctance in the gap that is higher than normal, thereby resulting in a portion of the rotor flux that extends through the shaft of the electric motor along a path of lower reluctance increasing as compared with the bridging of the gap with higher reluctance. The loss of flux through the shaft of small integrated pumps may typically be up to 13%. To compensate for this loss of stray flux, the length of the electric motor must be increased by 13%, or a non-magnetic shaft made of stainless steel must be used. Both of these options increase the costs of the electric motor considerably.

To illustrate, FIG. 8 shows a two-dimensional cross section of a small, brushless, four-poled, three-phase, permanent magnetic electric motor with six teeth with a buried NdFeB-permanent magnet, consequent-pole rotor design, i.e., a top view of a metal lamellar sheet 1 of the core, which is composed of metal lamellar sheets, and a metal lamellar sheet 4 of the stator, which is composed of metal lamellar sheets. The figure also shows two permanent magnets 5, in a cross-sectional view. FIG. 9 shows the two-dimensional magnetic field in the machine that exists when it is not excited, and which was calculated using finite-element analysis and assuming that the motor shaft is not magnetic. Phase windings are left out of FIGS. 8 and 9, for clarity. FIG. 10 shows a schematic, two-dimensional depiction of the magnetic field shown in FIG. 9 that exists in the rotor when the motor shaft is magnetic. The lines of the magnetic flux that generate the four-poled field are shown clearly in the figure along with the stray magnetic flux in the shaft. FIG. 11 shows a schematic, three-dimensional depiction of the magnetic field in the rotor, and the stray magnetic flux flowing in the shaft is clearly shown. This stray flux diminishes the four-poled field and thereby reduces the flux in the gap, the torque, and the output-to-weight ratio of the electric motor.

### ADVANTAGES OF THE INVENTION

In contrast, the inventive rotor with the features of claim 1 has the advantage that the stray flux flowing in the motor shaft is also minimized or prevented when a magnetic motor shaft is used. As a result, the flux in the gap, the torque, and the output-to-weight ratio of the electric motor are not reduced. This is attained according to the present invention in that the metal lamellar sheets of the core of the rotor are composed of a two-state steel, and they have a low relative permeability in an inner region in which the motor shaft is attached to the metal lamellar sheets. According to the present invention, metal lamellar sheets made of two-state steel are therefore used for the rotor core of permanent-magnet, consequent-pole machines to prevent loss of flux along the magnetic steel shaft of the electric motor. To this end, the metal lamellar sheets, which are composed of two-state steel, are heat-treated locally and demagnetized in the region in which the rotor laminated core is connected with the motor shaft. The demagnetized material, which has the magnetic properties of air, generates a flux barrier of the rotor stack in the magnetic steel shaft. As a result, and according to the present invention, there is no need to use a non-magnetic shaft made of stainless steel, and the machine need not be designed longer in length in order to compensate for the flux losses. According to the present invention, the radial width of the non-magnetic flux barrier preferably has approximately the same width as does the magnetic gap of the electric motor, or it is slightly greater. The inner region, in which the motor shaft is attached to the metal lamellar sheets, has a low relative permeability. According to the present invention, this inner region is preferably a concentric ring around the motor shaft and/or the opening provided therefore, the width of which corresponds to that of the magnetic gap between the rotor and the stator.

Similarly, the inventive method for manufacturing a rotor for an electrical machine that includes a core composed of metal lamellar sheets located on a motor shaft includes the following steps:
Manufacture the metal lamellar sheets using a two-state steel with a high relative permeability, and
Apply heat treatment to the metal lamellar sheets in an inner region, in which the motor shaft is attached to the metal lamellar sheets, so that a low relative permeability results there.

The subclaims show preferred refinements of the present invention.

According to the present invention, the inner region preferably includes all contact points between a metal lamellar sheet and the motor shaft. According to the present invention, this is preferably attained by heat-treating the metal lamellar sheets and/or the core such that all contact points between the metal lamellar sheet and the motor shaft have a low relative permeability.

With the inventive rotor, the metal lamellar sheets preferably have a high relative permeability in an outer region located outside of the inner region. It is preferably 900 or higher. According to the present invention, the low relative permeability is preferably approximately 1.

According to the present invention, the heat treatment preferably includes warming the inner region to temperatures above 1100° C. According to the present invention, the inner region is preferably warmed by moving a plasma welding head—or by using a similar method—over the inner region.

The inventive rotor is preferably adapted to a brushless, permanent-magnet, consequent-pole machine.

### BRIEF DESCRIPTION OF THE DRAWING

Exemplary embodiments of the present invention are described below with reference to the attached drawing.

FIG. 1 shows a cross section of a small, brushless, permanent-magnet, consequent-pole machine for a pump, according to a first exemplary embodiment of the present invention;

FIG. 2 shows a depiction of the two-dimensional magnetic field of the machine shown in FIG. 1 when the phase windings are not excited;

FIG. 3 shows a schematic, two-dimensional depiction of the magnetic field present in the rotor and shown in FIG. 2;

FIG. 4 shows a schematic, three-dimensional depiction of the magnetic field present in the rotor and shown in FIG. 2;

FIG. 5 shows a comparison of the electromotive force of a conventional electric motor and that of an inventive electric motor;

FIG. 6 shows a comparison of the torque-to-rotational speed and drive efficiency-to-rotational speed of a conventional electric motor with an inventive electric motor;

FIG. 7 shows various configurations of interference connections between the rotor stack and the motor shaft according to the present invention;

FIG. 8 shows a cross section of a conventional, small, brushless, permanent-magnet, consequent-pole machine;

FIG. 9 shows a depiction of the two-dimensional magnetic field of the electric motor shown in FIG. 8 when the phase windings are not excited;

FIG. 10 shows a schematic, two-dimensional depiction of the magnetic field present in the rotor and shown in FIG. 8; and

FIG. 11 shows a schematic, three-dimensional depiction of the magnetic field present in the rotor and shown in FIG. 8.

### EMBODIMENT(S) OF THE INVENTION

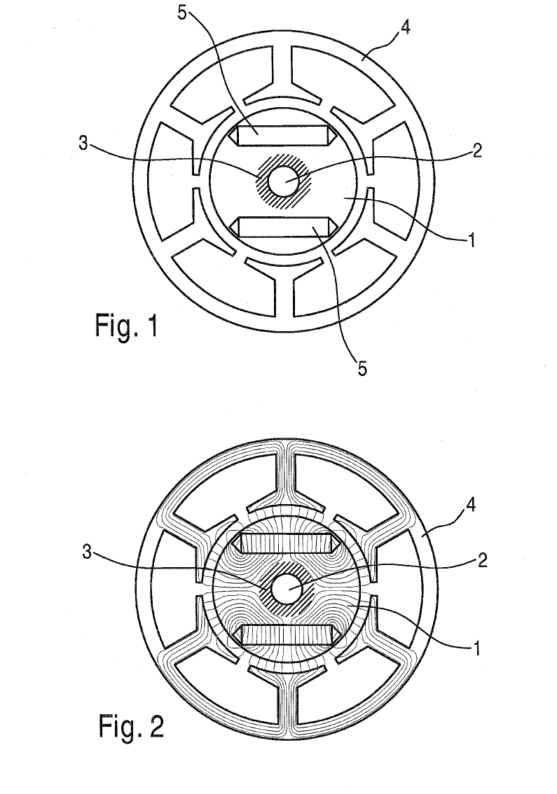

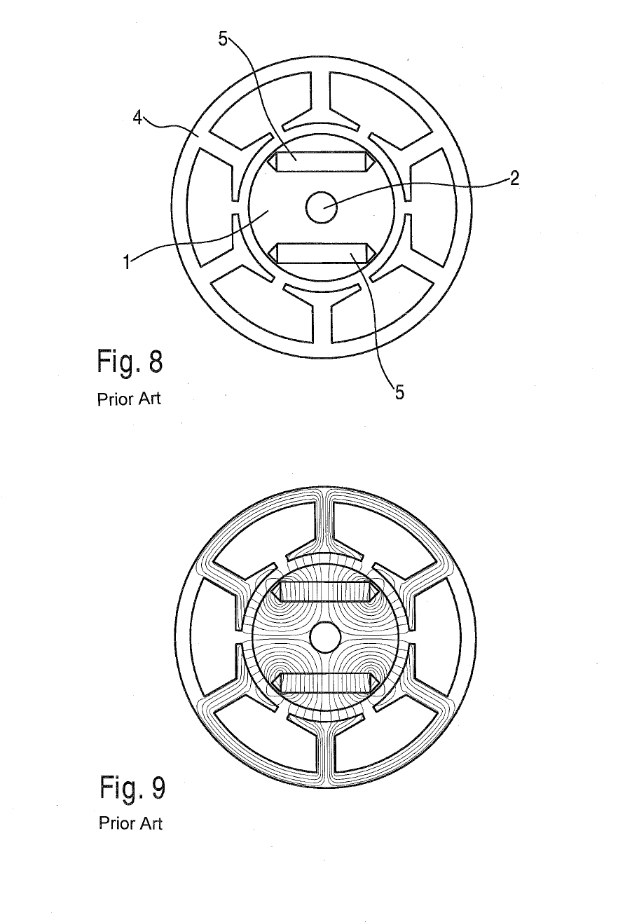

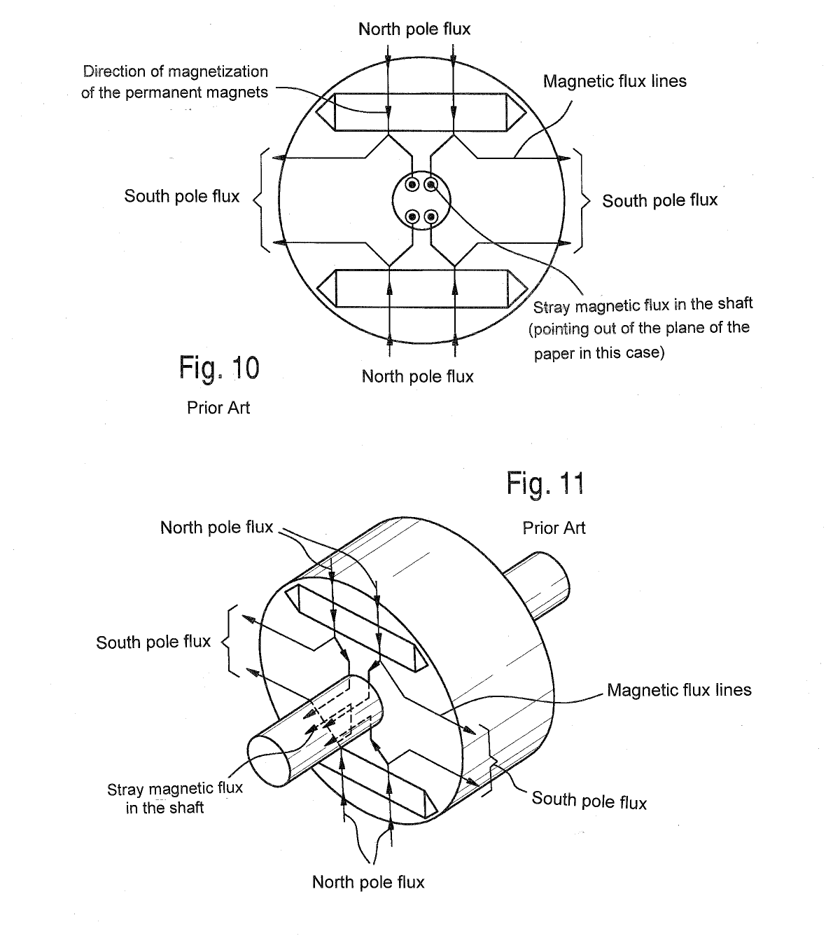

FIG. 1 shows a cross section of a brushless, permanent-magnet, consequent-pole machine as a preferred embodiment of the present invention. It basically has the same design as that of a conventional electric motor of the same type, as shown in FIG. 8. According to the present invention, a two-state steel is used for metal lamellar sheets 1 of the rotor. Metal lamellar sheets 1 are heat-treated and demagnetized in region 3 around motor shaft 2, in order to produce an inner region 3 that is not magnetic and behaves as effectively as air. This non-magnetic flux barrier is shown in the figure as a shaded ring 3 that encloses motor shaft 2 entirely, i.e., by 360°. According to the present invention, the radial width of this flux barrier is preferably equal to or slightly larger than the gap width between the rotor and the stator, i.e., it is as great as or greater than (by up to 50%) as the difference between the outer diameter of metal lamellar sheets 1 of the rotor and the inner diameter of metal lamellar sheets 4 of the stator.

The demagnetization is preferably carried out using heat treatment, in which inner region 3 is warmed to temperatures above 1100° C. This is preferably carried out by moving a plasma welding head—or by using a similar method—across or along inner region 3. This step may be carried out when metal lamellar sheets 1 have not yet been stacked to form rotor laminations, or after the rotor laminations have been assembled, by moving the plasma welding head through the region provided for motor shaft 2.

FIG. 2 shows the two-dimensional magnetic field—which was calculated using finite-element analysis—in the non-excited electric motor. It is shown clearly in the figure that a magnetic flux does not enter inner region 3. As a result, stray flux may not occur in the motor shaft even when a magnetic steel shaft is used. Loss of flux is therefore prevented.

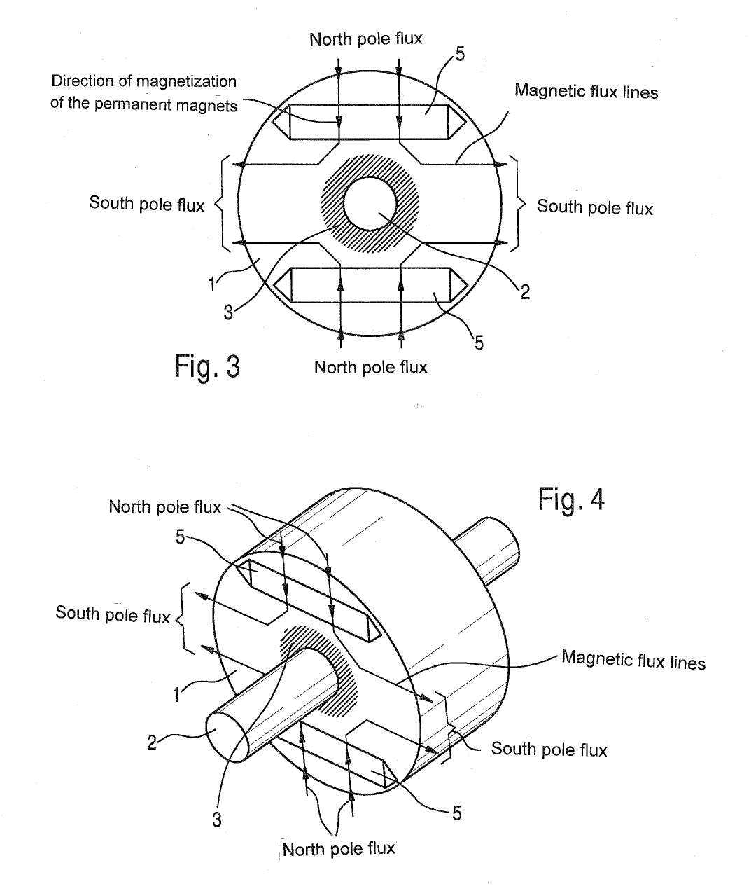

FIG. 3 shows a schematic, two-dimensional depiction of the magnetic field in FIG. 2 that exists in the rotor. The lines of the magnetic flux that generate the four-poled field are clearly shown in the figure; it is obvious that they do not enter inner region 3, which is designed as a concentric ring around motor shaft 2.

FIG. 4 shows a schematic, three-dimensional depiction of the magnetic field in the rotor. Here, it is also clear that magnetic flux does not enter motor shaft 2. As a result, there are no losses in the gap flux or torque, and no reduction in the output-to-weight ratio of the electric motor.

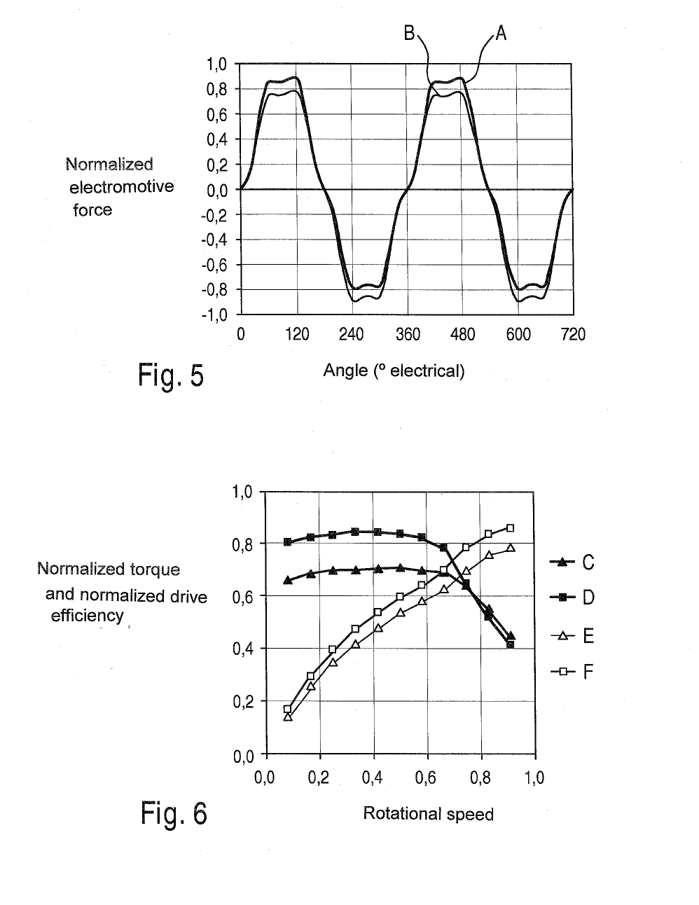

FIG. 5 shows a comparison of the normalized electromotive force of the conventional electric motor shown in FIG. 8 with the inventive electric motor shown in FIG. 1. Curve A represents the electric motor designed according to the present invention, and curve B represents the electric motor with the conventional design. It is clear that the inventive electric motor produces a greater normalized electromotive force. It therefore also has a higher magnetic flux. The difference between curves A and B is due to the stray magnetic flux, which becomes lost through motor shaft 2 of the conventional electric motor.

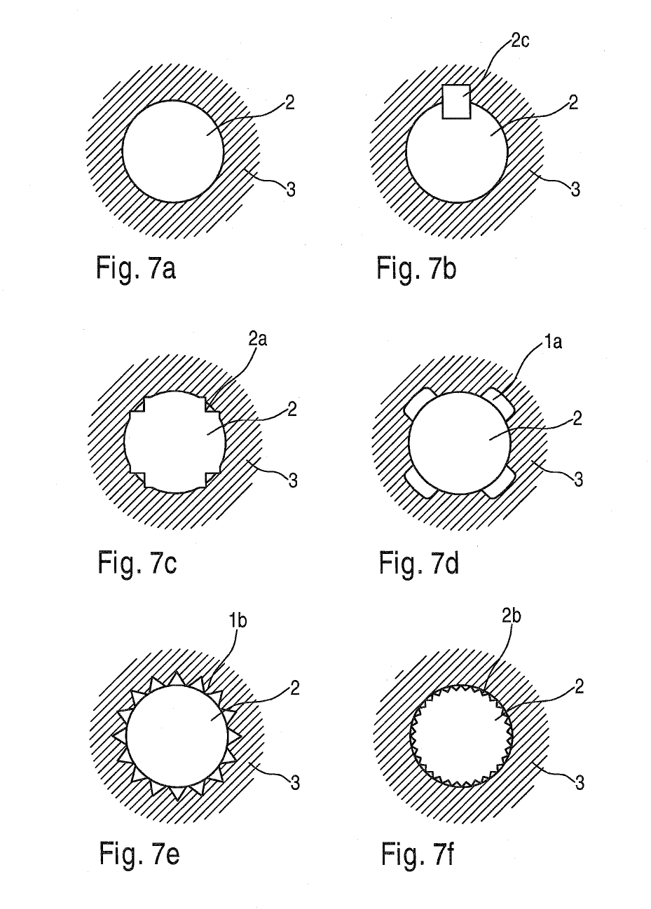

FIG. 6 shows the normalized torque and the normalized drive efficiency of the two electric motors shown in FIGS. 8 and 1 plotted against the normalized rotational speed. Curve C represents the torque of the conventional motor, and curve D represents the torque of the inventive motor. Curve E represents the drive efficiency of the conventional motor, and curve F represents the drive efficiency of the inventive motor. The drive efficiency includes the electric motor plus the power and control electronics. FIG. 6 shows clearly that the torque and drive efficiency of the inventive motor are higher.

FIG. 7 shows various types of connections of the rotor laminations with motor shaft 2 that are commonly used with small electric motors. The rotor stack composed of the two-state metal lamellar sheets was heat-treated and demagnetized in inner region 3 of each metal lamellar sheet, i.e., in the inner region of the rotor stack, in order to create a non-magnetic region that behaves as effectively as air, to create a flux barrier and prevent magnetic flux from entering motor shaft 2. FIG. 7a shows a shank with a simple round cross section that is connected with the rotor stack via an interference fit. FIG. 7b shows a motor shaft 2 with a keyway and a key 2c inserted therein, which also engages in a groove of the rotor stack, thereby preventing inserted motor shaft 2 from rotating relative to the rotor stack. FIG. 7c shows a motor shaft provided with notches 2a, via which, when the motor shaft is inserted in the rotor stack, the motor shaft and rotor stack are prevented from rotating relative to each other. FIG. 7d shows a motor shaft with a round cross section that has been inserted in a rotor stack, in the case of which the lamellas include slots la, which extend along the entire stack and parallel with motor shaft 2, thereby resulting in an easier interference fit, which prevents rotation between motor shaft 2 and the rotor stack. The number of slots is greater than or equal to 2. FIG. 7e shows a motor shaft with a round cross section, which has been inserted in a rotor stack with toothed lamellas. This results in the same effect as was described with reference to FIG. 7d. The number of teeth is greater than or equal to 3. FIG. 7f shows a knurled motor shaft 2 with knurling 2b, the motor shaft 2 having been inserted in a rotor stack, in the case of which the metal lamellar sheets each includes a circular punched-out area for accommodating knurled motor shaft 2.

Individuals skilled in the technical art in the field of small electric motors clearly understand that other methods exist for connecting the motor shaft and rotor stack, and that they may also be used with the inventive rotor stack.

The present invention may be used with any permanent-magnet, consequent-field machine with a radial field.

What is claimed is:

1. A rotor for an electric machine that includes a core made of metal lamellar sheets (1) located on a motor shaft (2),
wherein
the metal lamellar sheets (1) of the core are made of a two-state steel and have a low relative permeability in an inner region (3) in which the motor shaft (2) is attached to the metal lamellar sheets (1).

2. The rotor as recited in claim 1,
wherein
the inner region (3) includes all contact points between a metal lamellar sheet (1) and the motor shaft (2).

3. The rotor as recited in claim 1,
wherein
the metal lamellar sheets (1) have a high relative permeability in an outer region located outside of the inner region (3).

4. The rotor as recited in claim 3,
wherein
the high relative permeability is 900 or higher.

5. The rotor as recited in claim 1,
wherein
the low relative permeability is approximately 1.

6. The rotor as recited in claim 1,
wherein
it is adapted for use with a brushless, permanent-magnet, consequent-pole machine.

8. A method for manufacturing a rotor for an electrical machine that includes a core composed of metal lamellar sheets (1) located on a motor shaft (2), characterized by the steps:
Manufacture the metal lamellar sheets (1) using a two-state steel with a high relative permeability, and
Apply heat treatment to the metal lamellar sheets (1) in an inner region (3), in which the motor shaft (2) is attached to the metal lamellar sheets (1), so that a low relative permeability results there.

9. The method as recited in claim 8,
wherein
the high relative permeability is 900 or higher.

10. The method as recited in claim 8,
wherein
the low relative permeability is approximately 1.

11. The method as recited in claim 8,
wherein
the heat treatment includes warming the inner region (3) to temperatures above 1100° C.

12. The method as recited in claim 11,
wherein
the inner region (3) is warmed by moving a plasma welding head—or by using a similar method—across the inner region (3).

13. The method as recited in claim 8,
wherein
the metal lamellar sheets (1) and/or the core are heat-treated in such a manner that all contact points between a metal lamellar sheet (1) and the motor shaft (2) have a low relative permeability.

14. An electrical machine, in particular a brushless electric motor, characterized by a rotor as recited in claim 1.
